(19) United States
(12) Patent Application Publication
(10) Pub. No.: US 2017/0351867 A1
(43) Pub. Date: Dec. 7, 2017

(54) Method and Device for Securely Storing Data and for Accessing Said Data

(71) Applicant: GIESECKE & DEVRIENT GMBH, München (DE)

(72) Inventor: Rainer URIAN, Augsburg (DE)

(21) Appl. No.: 15/536,926

(22) PCT Filed: Dec. 14, 2015
(86) PCT No.: PCT/EP2015/002513

§ 371 Date: Jun. 16, 2017

(30) Foreign Application Priority Data
Dec. 17, 2014 (DE) 10 2014 018 889.2

(51) Int. Cl. G06F 21/62; H04L 9/08

(52) U.S. Cl. CPC G06F 21/6209; H04L 9/0897; H04L 9/0861; H04L 9/0891

(57) ABSTRACT

A method for securely storing data on a terminal by means of a portable data carrier, wherein an attribute vector and a master key are deposited on the portable data carrier. The method comprises deriving a key from a predicate and the master key by means of a key derivation function, wherein the predicate is a Boolean function of the attribute vector; encrypting the data with the key; and storing the encrypted data together with the predicate on the terminal. Another method comprises: extracting the predicate from the encrypted data and the predicate; applying the predicate to the attribute vector; and if the attribute vector satisfies the predicate, deriving the key from the predicate and the master key by means of the key derivation function and decrypting the encrypted data.

### FIELD OF THE INVENTION

The invention relates to the field of storing data and of accessing these data. The invention relates in particular to a method and an apparatus for securely storing data and for accessing these data.

### BACKGROUND OF THE INVENTION

More and more data are available in digital form. These data must be stored, and normally in a secure fashion. The secure storing of data can be regarded as a field of cryptography in which the plaintext, the data, are sent in encrypted form to the user at a point in the future.

In a secure environment an access control mechanism can be readily realized. In an insecure environment (e.g. in the cloud) this is not possible, because the access control mechanism is no longer trustworthy.

Against this background it is the object of the present invention to provide improved methods and apparatuses for securely storing data, and in particular for securely storing data in insecure environments.

### SUMMARY OF THE INVENTION

The above-mentioned objects are achieved by the subject matter of the independent claims. Preferred embodiments are defined in the dependent claims.

According to a first aspect of the invention, a method for securely storing data D on a terminal by means of a portable data carrier is provided, wherein an attribute vector A and a master key MK are deposited on the portable data carrier. The method comprises the following steps: deriving a key K from a predicate P and the master key MK by means of a key derivation function KDF, wherein the predicate P is a Boolean function of the attribute vector A; encrypting the data D with the key K; and storing the encrypted data D together with the predicate P on the terminal.

Preferably, the key K is destroyed after the encryption of the data D with the key K.

According to preferred embodiments of the invention the master key MK is a global master key.

According to a second aspect of the invention, a method for accessing encrypted data D by means of a portable data carrier is provided, which data have been stored on a terminal by means of a method according to the first aspect of the invention. The method comprises the following steps: extracting the predicate P from the encrypted data and the predicate P; applying the predicate P to the attribute vector A; and if the attribute vector A satisfies the predicate P, deriving the key K from the predicate P and the master key MK by means of the key derivation function KDF and decrypting the encrypted data D.

According to a third aspect of the invention, a method for securely storing data D on a terminal by means of a portable data carrier is provided, wherein a predicate P and a master key MK are deposited on the portable data carrier. The method comprises the following steps: deriving a key K from an attribute vector A and the master key MK by means of a key derivation function KDF, wherein the predicate P is a Boolean function of the attribute vector A; encrypting the data D with the key K; and storing the encrypted data D together with the attribute vector A on the terminal.

Preferably, the key K is destroyed after the encryption of the data D with the key K.

According to preferred embodiments of the invention the master key MK is a global master key.

According to a fourth aspect of the invention, a method for accessing encrypted data D by means of a portable data carrier is provided, which data have been stored on a terminal by means of a method according to the third aspect of the invention. The method comprises the following steps: extracting the attribute vector A from the encrypted data D and the attribute vector A; applying the predicate P to the attribute vector A; and if the attribute vector A satisfies the predicate P, deriving the key K from the attribute vector A and the master key MK by means of the key derivation function KDF and decrypting the encrypted data D.

According to a fifth aspect of the invention, a portable data carrier is provided, which is configured to store data D on a terminal according to a method of the first aspect of the invention or the third aspect of the invention or to access data D on a terminal according to a method of the second aspect of the invention or the fourth aspect of the invention.

According to a sixth aspect of the invention, a terminal is provided, which is configured for storing data D on the terminal according to a method of the first aspect of the invention or of the second aspect of the invention or for accessing data D on the terminal according to a method of the second aspect of the invention or the fourth aspect of the invention.

Further features, advantages and objects of the invention will emerge from the following detailed description of several embodiment examples and embodiment alternatives. Reference is made to the drawings, in which there are shown:

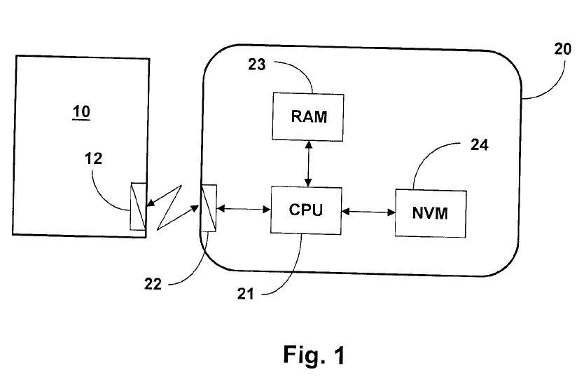

FIG. 1 a schematic representation of a portable data carrier of the invention in communication with a terminal,

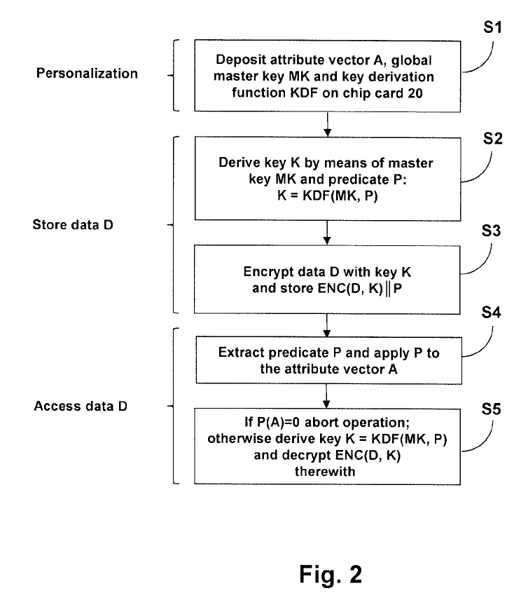

FIG. 2 the steps of a method for storing data with the portable data carrier of FIG. 1 according to a first preferred embodiment of the invention, and

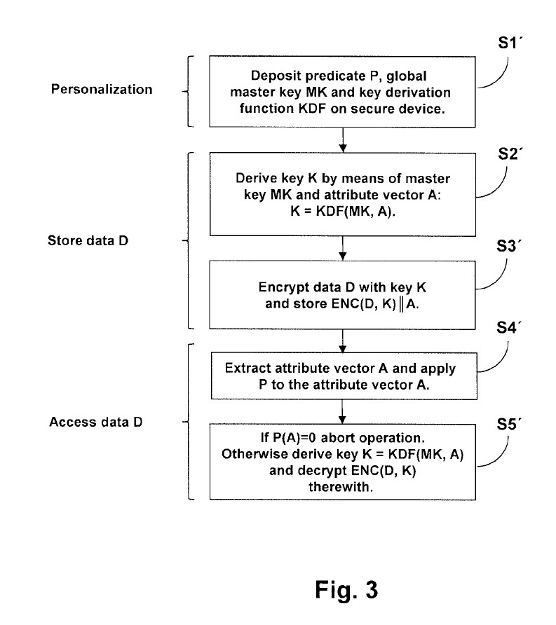

FIG. 3 the steps of a method for storing data with the portable data carrier of FIG. 1 according to a second preferred embodiment of the invention.

FIG. 1 shows a schematic representation of a preferred embodiment of a portable data carrier according to the invention in the form of a chip card 20 in communication with an external entity in the form of a terminal 10.

The portable data carrier in the form of a chip card 20 as represented in FIG. 1 is configured to exchange data with the reader 10. An exchange of data is understood here to be a signal transmission, a mutual control and in simple cases also a connection between the reader 10 and the chip card 20. In information theory a data exchange is characterized in particular by the transmitter-receiver model: data or information items are encoded into symbols and then transmitted from a transmitter to a receiver via a transmission channel. It is decisive here that transmitter and receiver employ the same coding in order that the receiver can decode the data.

For data transmission or communication between the chip card 20 and the terminal 10, both the chip card 20 and the terminal 10 have suitable communication interfaces 22 and 12. The interfaces 22 and 12 can be for example configured such that the communication therebetween or between the chip card 20 and the reader 10 is effected contactlessly, i.e. via the over-the-air interface, as indicated in FIG. 1 by the jagged arrow. Alternatively, the chip card 20 can be connected to the interface 12 of the terminal 10 via the interface 22 galvanically, i.e. in contact-type fashion. In this case, the interface 22 normally is configured as a contact pad arranged on one side of the chip card 20, with contact areas for data exchange with the terminal 10. The present invention of course also comprises portable data carriers in the form of chip cards having both an interface for contact-type communication with a terminal and an interface for contactless communication with a terminal, and which are known to the person skilled in the art as dual-interface chip cards.

Besides the interface 22 for communication with the terminal 10, the chip card 20 comprises a central processing unit (CPU; also called a processor) 21 which is in communication connection with the interface 22. As is known, the basic functions of the processor 21 are to execute arithmetic and logic functions and to read and write data elements, as is defined by a software application that runs on the processor 21. The processor 21 is further connected to a volatile working memory (RAM) 23 and a non-volatile re-writable memory 24 (in FIG. 1 referred to as “NVM” (non-volatile memory)). Preferably, the non-volatile memory 24 is a flash memory (flash EEPROM). It may be for example a flash memory with a NAND or a NOR architecture. Besides a re-writable part, the non-volatile memory 24 can further have a ROM.

In the preferred embodiment represented in FIG. 1, there is stored in the non-volatile memory 24 of the chip card 20 program code which can be executed by the processor 21. In particular, in the nonvolatile memory 24 of the chip card 20 there can be implemented program code by which the chip card 20 is configured to carry out the methods according to the invention for storing data on the terminal 10, which method is described below in connection with the FIGS. 2 and 3. The terminal 10 can be, for example, a cloud server which is configured for storing data thereon.

FIG. 2 shows a first preferred embodiment for storing data with the portable data carrier 20 on the terminal 10 or a background system being in communication therewith.

Step S1 of FIG. 1 relates to the personalization of the portable data carrier 20, which normally can be performed within the framework of the manufacture of the portable data carrier 20 by the manufacturer or subsequently by the issuer of the portable data carrier 20. According to step S1 of FIG. 2, upon the personalization an attribute vector A, a master key MK and a key derivation function KDF are deposited on the portable data carrier 20. The attribute vector A consists preferably of at least, but normally of several components, which each define a certain property (i.e. an attribute) of the user of the portable data carrier 20. Attributes of this kind are, for example, age, gender, body height, weight, security state, grade, department and the like. Preferably, the master key MK is a global master key, i.e. a master key deposited on a plurality of portable data carriers like the portable data carrier 20.

The data carrier 20 personalized according to step S1 of FIG. 2 can be employed according to the invention for securely storing data D on the terminal 10 or a background system being in communication therewith. For this purpose, by the terminal 10 there is provided in step S2 of FIG. 2 a predicate P. From the master key MK and the predicate there is derived a key K by means of the key derivation function KDF preferably in the secure environment provided by the portable data carrier 20. As described below in more detail, the predicate is a function which has the attribute vector A as an argument and returns the value 0 or 1 as a function value, i.e. it is a Boolean function which is applied to the attribute vector A. If, by way of example, the age of the user is a component of the attribute vector A, a query implemented in the predicate P could be whether the owner already is 18 years old, which is answered by predicate with 0 or 1. In practice, a predicate P could be deposited, for example, as a bit string by means of TLV coding. Preferably, the predicate can be selected by the user of the portable data carrier 20. As described in detail below, by the selection of a suitable predicate P the user of the portable data carrier 20 can determine which persons (i.e. which group of people determined by the attribute vector A) have access to the data D.

In step S3 of FIG. 2, the data D are encrypted with the key K and the encrypted data ENC(D, K) are stored together with the predicate P on the terminal 10 (or a background system being in communication therewith). Preferably, after the encryption with the key K this key is deleted. According to the invention, the encryption can by performed by the portable data carrier 20 as well as by the terminal 10. For the joint storage of the encrypted data ENC(D, K) and the predicate P, these can preferably be concatenated with each other, which is indicated in FIG. 2 by the symbol “∥”.

After the data D have been securely stored in the steps S2 and S3 of FIG. 2, these can be accessed according to the invention by means of the steps S4 and S5 of FIG. 2.

In step S4 of FIG. 2, the predicate P is extracted from the data packet stored on the terminal 10 in step S3, which data packet consists of the encrypted data ENC(D, K) and the predicate P. Subsequently, the predicate P extracted in this way is applied to the attribute vector A deposited on the portable data carrier 20. As already described above, the predicate P is a Boolean function, which with the attribute vector A as an argument can return two function values, preferably 0 or 1. Preferably, P(A)=0 means here that the attribute vector A does not satisfy the predicate P, while P(A)=1 means that the attribute vector A satisfies the predicate P.

According to the invention, in step S5 of FIG. 2 there is now provided that when the attribute vector A does not satisfy the predicate P (which is the case in the above example P(A)=0), an access to the data D is denied. Only when the attribute vector A satisfies the predicate P (which is the case in the above example P(A)=1) the key K is derived from the master key MK deposited on the portable data carrier 20 and the predicate P by means of the key derivation function KDF. As this key has been derived in step S2 of FIG. 2 and been employed to encrypt the data D, the data D can be decrypted with this key in step S5, thereby enabling the user of the portable data carrier 20 to again access the data D (or a user of a different portable data carrier whose attribute vector A′ also satisfies the predicate P and has available the same global master key MK).

FIG. 3 shows a second preferred embodiment of the invention for storing data with the portable data carrier 20 on the terminal 10 or a background system being in communication therewith. The second preferred embodiment of FIG. 3 differs from the first preferred embodiment of FIG. 2 substantially in that in the second preferred embodiment the roles of the predicate P and the attribute vector A are interchanged. Here, in step S3′ of FIG. 3 as shown preferably the attribute vector A or alternatively the predicate P can be employed for the derivation of the key K (as well as in the corresponding derivation in step S5′ of FIG. 3). As, except for the interchanging of the roles of the predicate P and the attribute vector A, there are no further differences between the second preferred embodiment shown in FIG. 3 and the first preferred embodiment shown FIG. 2 reference can be made to the description of the steps S1 to S5 hereinabove.

1-10. (canceled)

11. A method for securely storing data D by means of a portable data carrier on a terminal, wherein on the portable data carrier there are deposited an attribute vector A and a master key MK, wherein the method comprises the following steps:
deriving a key K from a predicate P and the master key MK by means of a key derivation function KDF, wherein the predicate P is a Boolean function of the attribute vector A;
encrypting the data D with the key K; and
storing the encrypted data D together with the predicate P on the terminal.

12. The method according to claim 11, wherein after encrypting the data D with the key K the key K is destroyed.

13. The method according to claim 11, wherein the master key MK is a global master key.

14. A method for accessing encrypted data D by means of a portable data carrier, which encrypted data have been stored by means of a method according to claim 11 on a terminal, wherein the method comprises the following steps:
extracting the predicate P from the encrypted data and the predicate P;
applying the predicate P to the attribute vector A; and
if the attribute vector A satisfies the predicate P, deriving the key K from the predicate P and the master key MK by means of the key derivation function KDF and decrypting the encrypted data D.

15. A method for securely storing data D by means of a portable data carrier on a terminal, wherein on the portable data carrier there are deposited a predicate P and a master key MK, wherein the method comprises the following steps:
deriving a key K from an attribute vector A and the master key MK by means of a key derivation function KDF, wherein the predicate P is a Boolean function of the attribute vector A;
encrypting the data D with the key K; and
storing the encrypted data D together with the attribute vector A on the terminal.

16. The method according to claim 15, wherein after encrypting the data D with the key K the key K is destroyed.

17. The method according to claim 15, wherein the master key MK is a global master key.

18. A method for accessing encrypted data D by means of a portable data carrier, which encrypted data have been stored by means of a method according to claim 15 on a terminal, wherein the method comprises the following steps:
extracting the attribute vector A from the encrypted data D and the attribute vector A;
applying the predicate P to the attribute vector A; and
if the attribute vector A satisfies the predicate P, deriving the key K from the attribute vector A and the master key MK by means of the key derivation function KDF and decrypting the encrypted data D.

19. A portable data carrier which is configured to store data D on a terminal according to claim 11 or to access data D on a terminal according to a method for securely storing data D by means of a portable data carrier on a terminal, wherein on the portable data carrier there are deposited a predicate P and a master key MK, wherein the method comprises the following steps:
deriving a key K from an attribute vector A and the master key MK by means of a key derivation function KDF, wherein the predicate P is a Boolean function of the attribute vector A;
encrypting the data D with the key K; and
storing the encrypted data D together with the attribute vector A on the terminal.

20. A portable data carrier which is configured to store data D on a terminal according to claim 15 or to access data D on a terminal according to a method for securely storing data D by means of a portable data carrier on a terminal, wherein on the portable data carrier there are deposited a predicate P and a master key MK, wherein the method comprises the following steps:
deriving a key K from an attribute vector A and the master key MK by means of a key derivation function KDF, wherein the predicate P is a Boolean function of the attribute vector A;
encrypting the data D with the key K; and
storing the encrypted data D together with the attribute vector A on the terminal.

21. A terminal which is configured for storing data D on the terminal according to claim 11 or for accessing data D on the terminal according to a method for securely storing data D by means of a portable data carrier on a terminal, wherein on the portable data carrier there are deposited a predicate P and a master key MK, wherein the method comprises the following steps:
deriving a key K from an attribute vector A and the master key MK by means of a key derivation function KDF, wherein the predicate P is a Boolean function of the attribute vector A;
encrypting the data D with the key K; and
storing the encrypted data D together with the attribute vector A on the terminal.

22. A terminal which is configured for storing data D on the terminal according to claim 15 or for accessing data D on the terminal according to a method for securely storing data D by means of a portable data carrier on a terminal, wherein on the portable data carrier there are deposited a predicate P and a master key MK, wherein the method comprises the following steps:
deriving a key K from an attribute vector A and the master key MK by means of a key derivation function KDF, wherein the predicate P is a Boolean function of the attribute vector A;
encrypting the data D with the key K; and
storing the encrypted data D together with the attribute vector A on the terminal.
